(19) United States
(12) Patent Application Publication
(10) Pub. No.: US 2025/0328264 A1
(43) Pub. Date: Oct. 23, 2025

(54) ADJUSTED ACCESS OPERATIONS FOR REPLAY PROTECTED MEMORY BLOCKS

(71) Applicant: Micron Technology, Inc., Boise, ID (US)

(72) Inventors: Jiawei Wang, Shanghai (CN); Jianfeng Li, Shanghai (CN)

(21) Appl. No.: 19/097,499

(22) Filed: Apr. 1, 2025

Related U.S. Application Data
(60) Provisional application No. 63/636,011, filed on Apr. 18, 2024.

(51) Int. Cl. G06F 3/06

(52) U.S. Cl. CPC G06F 3/0622; G06F 3/0659; G06F 3/0679

(57) ABSTRACT

Methods, systems, and devices for adjusted access operations for replay protected memory blocks (RPMBs) are described. A memory system may communicate one or more commands concurrently with performance of an access operation on a RPMB in response to receiving a first security protocol command. The first security protocol command may be a security protocol out (SPO) command transmitted from a host device. In combination with a ready to transfer response from the memory system and a data out UPIU from the host device, the first security protocol command may indicate a type of the access operation and corresponding data. The one or more commands may include additional SPO commands, security protocol in (SPI) commands, one or more other commands, or any combination thereof. In some cases, the memory device may transmit the data back to the host after the access operation is complete.

### CROSS REFERENCE

The present Application for Patent claims priority to U.S. Patent Application No. 63/636,011 by Wang et al., entitled “ADJUSTED ACCESS OPERATIONS FOR REPLAY PROTECTED MEMORY BLOCKS,” filed Apr. 18, 2024, which is assigned to the assignee hereof, and which is expressly incorporated by reference in its entirety herein.

### TECHNICAL FIELD

The following relates to one or more systems for memory, including adjusted access operations for replay protected memory blocks.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports adjusted access operations for replay protected memory blocks (RPMBs) in accordance with examples as disclosed herein.

FIGS. 2 and 3 show examples of a processes that supports adjusted access operations for RPMBs in accordance with examples as disclosed herein.

FIG. 4 shows a block diagram of a memory system that supports adjusted access operations for RPMBs in accordance with examples as disclosed herein.

FIG. 5 shows a flowchart illustrating a method or methods that support adjusted access operations for RPMBs in accordance with examples as disclosed herein.

### DETAILED DESCRIPTION

Some memory systems may include one or more blocks of access protected memory cells, such as replay protected memory blocks (RPMBs), which may store data in a protected manner. To access an access protected memory cell (such as an RPMB or another type of access protected memory) of a memory system, a host device and the memory system may communicate (e.g., exchange) one or more security protocol commands. The security protocol commands may include a sequence of commands which, when received in order, may instruct the memory device to perform an access operation (e.g., a read operation, a write operation) and return (e.g., subsequent to performing the operation) the data to the host device. The returned data may indicate information about the access command (e.g., success, failure, memory location) and/or data transferred or processed during the access operation. In some cases, the memory system may refrain from exchanging security protocol commands (e.g., and other commands) while performing an access operation on the RPMB. In such cases, accessing the RPMB of the memory system may be associated with a relatively high latency (e.g., compared to access operations for other unprotected portions of memory in the memory system) due to the memory system exchanging security protocol commands and performing access operations in series (e.g., non-concurrently or in other words non-overlapping).

According to techniques described herein, a memory system may perform an access operation on an access protected memory (such as an RPMB or another type of access protected memory) directly in response to (e.g., after, based on) receiving a first security protocol command, and may communicate one or more other (e.g., remaining) commands (e.g., including security protocol commands) concurrently with performing the access operation. In some cases, the first security protocol command of the sequence of commands may be or include a security protocol out (SPO) command transmitted from the host device. The first security protocol command may, in combination with a ready to transfer response (e.g., a ready to transfer universal flash storage (UFS) protocol information unit (UPIU)) from the memory system and a data out UPIU from the host device, indicate a type of the access operation (e.g., read, write) and corresponding data. The remaining one or more commands (e.g., subsequent commands) in the sequence of commands may include one or more additional SPO commands (e.g., for write operations), one or more security protocol in (SPI) commands that may request transmission of the data or other information back to the host, one or more other commands, or any combination thereof. In some cases, the memory device may transmit the data back to the host (e.g., via a data in UPIU) after the access operation is complete. Benefits of implementing the techniques described herein may include a reduced latency for access operations, such as RPMB access operations. As used herein, a RPMB may represent and be illustrative of one or more types of access protected memory, including RPMBs or other types of memory blocks.

In addition to applicability in memory systems described herein, techniques for supporting adjusted access operations for RPMBs may be generally implemented to improve security features, authentication features, or both, of various electronic devices and systems. As the use of electronic devices for handling private, user, or other sensitive information has become even more widespread, electronic devices and systems have become the target of increasingly frequent and sophisticated attacks. Further, unauthorized access or modification of data in security-critical devices such as vehicles, healthcare devices, and others may be especially concerning. Implementing the techniques described herein may improve the security of electronic devices and systems by reducing a latency of writing to and reading from an RPMB, which provides for improved performance and security, among other benefits.

Features of the disclosure are illustrated and described in the context of systems, devices, and circuits. Features of the disclosure are further illustrated and described in the context of systems (e.g., memory systems), processes (e.g., process flow diagrams) and flowcharts.

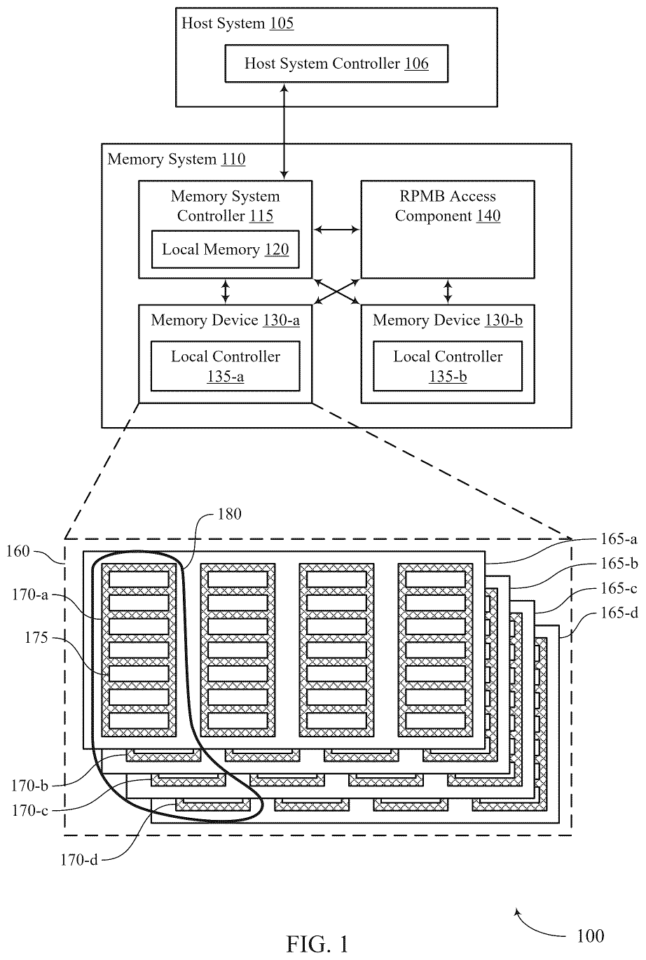

FIG. 1 shows an example of a system 100 that supports adjusted access operations for RPMBs in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a UFS device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or any combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is a managed NAND (MNAND) system.

The system 100 may include any quantity of non-transitory computer readable media that support adjusted access operations for RPMBs. For example, the host system 105 (e.g., a host system controller 106), the memory system 110 (e.g., a memory system controller 115), or a memory device 130 (e.g., a local controller 135) may include or otherwise may access one or more non-transitory computer readable media storing instructions (e.g., firmware, logic, code) for performing the functions ascribed herein to the host system 105, the memory system 110, or a memory device 130. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

In some cases, the memory system 110 may include one or more RPMBs. In some cases, an RPMB may be a partition in a flash-based storage devices (e.g., eMMC, UFS, non-volatile memory express (NVMe) or other types of storage devices), and may store data in an authenticated and replay protected way, such that the host system 105 (e.g., a host device) may access data in the RPMB by exchanging security protocol commands with the memory system 110. The exchanged security protocol commands may include a sequence of commands which instruct the memory system 110 to perform an access operation (e.g., a read operation, a write operation) and return (e.g., subsequent to performing the operation) data to the host system 105. In some cases, the returned data may indicate information about the access command (e.g., success, failure, memory location) or data transferred or processed during the access operation.

In some cases, a host system and a memory system may exchange the security protocol commands over a relatively long time period due to, for example, exchanging commands and performing access operations in series (e.g., not concurrently, not overlapping). Thus, accessing the RPMB of some memory systems may be associated with a relatively high latency (e.g., compared to access operations for other unprotected portions of memory of the memory system). In some aspects, the techniques described herein may provide for decreasing a latency for performing access operations in an RPMB of a memory system.

According to techniques described herein, the memory system 110 may communicate one or more commands concurrently with performing an access operation on an RPMB (e.g., or another type of access protected memory). The memory system 110 may perform the access operation in response to (e.g., after, based on) receiving a first security protocol command from the host system 105. The one or more commands may include remaining commands (e.g., including security protocol commands) associated with performing the access operation or receiving data associated with performing the access operation. In some cases, the first security protocol command may be an SPO command. The memory system 110 may additionally, or alternatively, transmit a ready to transfer response in response to the first security protocol command, and the memory system 110 may receive a data out UPIU from the host device prior to initiated the access operation. In response to these command(s), the memory system 110 may determine a type of the access operation (e.g., read, write), as well as corresponding data (e.g., read data, write data) to process during the access operation. The memory system 110 may transmit a response UPIU to the host system before, concurrently with, or after initiating the access operation according to the received commands.

The memory system 110 may communicate (e.g., receive, transmit) one or more remaining commands (e.g., subsequent commands) in the sequence of commands for accessing RPMB while performing the access operation (e.g., after initiating the access operation and before a time that the access operation is completed). In the case of a write operation, the remaining commands may include one or more additional SPO commands as well as one or more SPI commands that may request transmission of data to the host. In the case of a read operation, the remaining commands may include one or more SPI commands that may request transmission of data to the host system 105. In some cases, the memory device may transmit the data to the host system 105 after the access operation is complete.

In some cases, the memory system 110 (e.g., or each memory device in the memory system) may include an RPMB access component 140. In some cases, the RPMB access components 140 may perform the access operation, transmit or receive one or more commands of the sequence of commands concurrent with performing the access operation, or both. Additionally, or alternatively, one or more other components of the memory system 110 may perform the access operation, transmit or receive one or more commands of the sequence of commands, or both.

The system 100 may include any quantity of non-transitory computer readable media that support adjusted access operations for RPMBs. For example, the host system 105 (e.g., a host system controller 106), the memory system 110 (e.g., a memory system controller 115), or a memory device 130 (e.g., a local controller 135) may include or otherwise may access one or more non-transitory computer readable media storing instructions (e.g., firmware, logic, code) for performing the functions ascribed herein to the host system 105, the memory system 110, or a memory device 130. For example, such instructions, if executed by the host system 105 (e.g., by a host system controller 106), by the memory system 110 (e.g., by a memory system controller 115, an RPMB access component 140, or some other component), or by a memory device 130 (e.g., by a local controller 135), may cause the host system 105, the memory system 110, or the memory device 130 to perform associated functions as described herein.

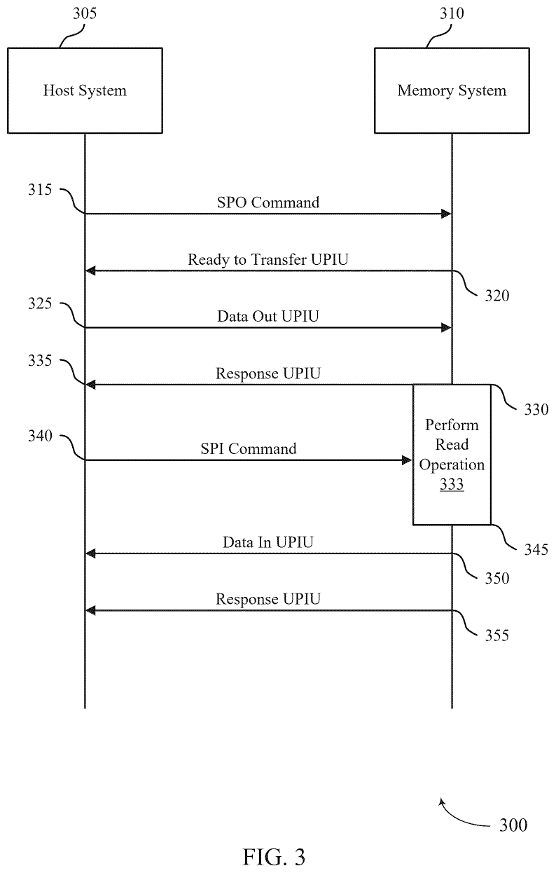

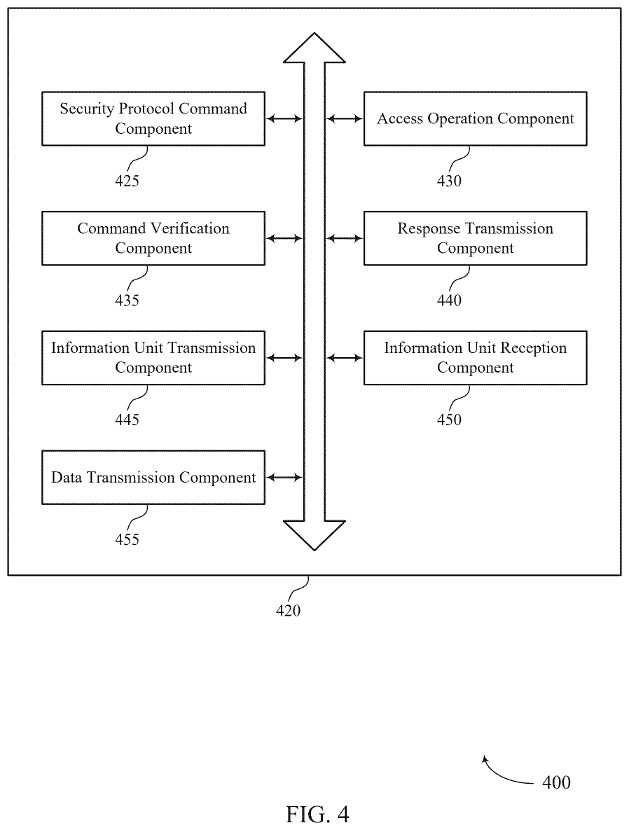

In some cases, the access operation may be a write operation or a read operation. In both types of access operations, the memory system 110 may communicate one or more commands concurrent with performing the access operation. In some examples, the communicated one or more commands may be the same or different during a write operation as compared to during a read operation. The techniques described herein may apply to both write and read operations of RPMBs, and are described in further detail elsewhere herein, including with respect to a process 200 (e.g., which may describe one application of these techniques during an RPMB write operation) and with respect to a process 300 (e.g., which may describe another application of these techniques during an RPMB read operation), as illustrated in FIGS. 3 and 4, respectively.

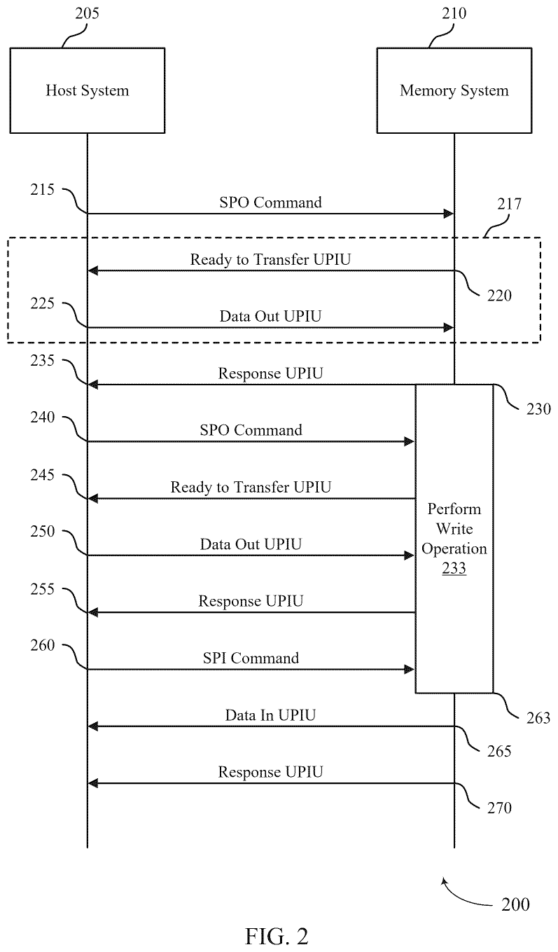

FIG. 2 shows an example of a process 200 that supports adjusted access operations for RPMBs in accordance with examples as disclosed herein. In some cases, aspects of the process 200 may implement or be implemented by aspects of FIG. 1. For example, the process 200 may include a host system 205 and a memory system 210, which may be examples of the host system 105 and the memory system 110, respectively, as described herein with respect to FIG. 1. In some aspects, the memory system 210 may communicate one or more security protocol commands associated with accessing memory in an RPMB concurrently with performing an RPMB write operation (e.g., a write operation 233).

In some cases, the process 200 may include communicating one or more security protocol commands. Security protocol commands may be commands that are employed by a security protocol, which may assist in keeping data secret, secure, or safe. Security protocol commands may include SPI commands and SPO commands, among other types of commands. The host system 205 may communicate SPI commands to retrieve information (e.g., results) regarding security protocols employed at the memory system 210, information regarding previous SPO commands (e.g., success, failure, associated data), or both. The host system 205 may transmit SPO commands to send data to the memory system 210, where the data may specify operations (e.g., one or more access operations, a transmit or receive operation) to be performed at the memory system 210. For example, an SPO command may indicate, to the memory system 210, to report the result of the operation (e.g., access operation) to the host system 205. As used herein, SPO commands and SPI commands may be associated with access to a RPMB of the memory system 210 (e.g., RPMB SPO commands, RPMB SPI commands).

In some cases, the security protocol commands may additionally, or alternatively, include response UPIUs, ready to transfer UPIUs, data in UPIUs, data out UPIUs, or any combination thereof. A UPIU may be a data structure deployed to transfer information between a UFS capable host and device. The memory system 210 may transmit a ready to transfer UPIU to the host system 205 (e.g., after receiving a security protocol command) to indicate that the memory system is ready to receive a data out command from the host system 205 (e.g., where the data out command may indicate data associated with the security protocol command). The memory system 210 may transmit a response UPIU to the host system 205 to indicate information associated with a corresponding command (e.g., SPO command, SPI command, data out command, data in command) or access operation. For example, the response UPIU may include a status notification, a success notification, a failure notification, or any combination thereof. In some cases, the host system 205 may communicate data out UPIUs to carry or indicate data to be processed (e.g., written, read) to the memory system 210. The host system 205 may communicate data in UPIUs with the memory system 210 to receive data from the memory system 210 associated with an access command.

In some cases, the memory system 210 may transmit a response UPIU to the host system 205 to indicate that the memory system 210 is ready to begin an access operation (e.g., a “GOOD” response). In some cases, the memory system 210 may transmit such a response UPIU (e.g., the “GOOD” response) in response to performing command verification on a corresponding SPO command, and successfully receiving the data (e.g., write data, read data) associated with the corresponding SPO command. In some cases, command verification may include determining that the command is from the host system 205 (e.g., and not another, possibly malicious, source) via a signature, or other verification process.

As described herein, the process 200 may describe a sequence of commands exchanged between the host system 205 and the memory system 210 for adjusted access to RPMBs. As is also described herein, an RPMB may be a portion of memory in a memory system (e.g., the memory system 210) that stores protected data. For example, the memory system may protect the data by verifying access request (e.g., access commands, access operations) prior to or concurrently with performing an access operation associated with the access request. In some cases, this form of protecting data may be called a security protocol. Thus, to interface with the RPMB of the memory system, a host system may exchange one or more security protocol commands with the memory system. In some aspects, the process 200 may include one or more security protocol commands that are part of a security protocol between the host system 205 and the memory system 210 to access one or more of the RPMBs of the memory system 210 according to techniques described herein.

In some memory systems, RPMB access operations may be associated with higher latency that other access operations (e.g., other access operations for non-protected memory). In some cases, the higher latency may result from the memory system performing the RPMB access operation sequentially with other commands (e.g., including other security protocol commands). That is, the memory system may not communicate other commands concurrent with performing an RPMB access operation. Such a procedure may add latency to receiving and performing actions associated with the other commands at the memory system, thus increasing latency associated with RPMB access commands at the memory system. However, by implementing techniques described herein, the memory system 210 may reduce or remove this higher latency.

According to the techniques described herein, the memory system 210 may communicate one or more commands (e.g., including security protocol commands) while performing an RPMB access command. For example, the memory system 210 may initiate an access operation for an RPMB in response to receiving and verifying a first security protocol command, and the memory system 210 may communicate one or more other commands concurrent with performing the access command. In the context of process 200, the access command may include a write command.

In the following description of process 200, the operations may be performed in a different order than the order shown, or other operations may be added or removed from the process 200. For example, some operations may also be left out of process 200, may be performed in different orders or at different times, or other operations may be added to process 200. Although the host system 205 and the memory system 210 are shown performing the operations of process 200, some aspects of some operations may also be performed by one or more other devices of a memory system, the host system 205, or the memory system 210. Additionally, each step that the host system 205 may be responsible for in process 200 may be implemented in instructions or firmware stored in memory of the host system 205 and executed by the host system controller 106. Similarly, each step that memory system 210 may be responsible for in the process 200 may be implemented in instructions or firmware stored in memory of the memory system 210 (e.g., memory device 130) and executed by the memory system controller 115, a local controller 135, or the RPMB access component 140, among other components.

At 215, a first security protocol command (e.g., a first SPO command) may be communicated. For example, a memory system (e.g., the memory system 210) may receive the first SPO command from a host system (e.g., the host system 205). In some cases, the first SPO command may be received at a controller (e.g., the memory system controller 115) or an RPMB access component (e.g., the RPMB access component 140) of the memory system. In some cases, the first SPO command may indicate data associated with an access operation for a memory array (e.g., an RPMB) of the memory system 210. For example, the data may include data to be written to the memory array, an address associated with the memory array, or both. In the example illustrated in FIG. 3, the first SPO command may indicate that the access operation is a write operation.

The process 200 may include a data transfer portion 217, where operations within the data transfer portion 217 may be looped, or performed iteratively. For example, host system 205 and the memory system 210 may repeat the operations within the data transfer portion 217 one or more times. In some cases, the operations of 220 and 225 may be repeated in order (e.g., perform operations of 220, then operations of 225, then repeat operations of 220, then repeat operations of 225, and so forth), or in any other order or pattern.

At 220, at least one first information unit (e.g., a first ready to transfer UPIU) may be transmitted. For example, the memory system 210 may transmit a first ready to transfer UPIU to the host system 205. In some cases, the controller (e.g., the memory system controller 115) or the RPMB access component 140 of the memory system 210 may transmit the first ready to transfer UPIU. In some cases, the first ready to transfer UPIU may indicate that the memory system 210 is ready to receive the data indicated by the first SPO command.

At 225, at least one second information unit (e.g., a first data out UPIU) may be received. For example, the memory system 210 may receive a first data out UPIU from the host system 205 in response to transmitting the ready to transfer UPIU of 220. In some cases, the controller (e.g., the memory system controller 115) or the RPMB access component 140 of the memory system 210 may receive the first data out UPIU. The first data out UPIU may contain at least a portion of the data indicated by the first SPO command. For example, the access operation indicated by the first SPO command may be the write operation 233, and may be to write the indicated data in response to receiving the first data out UPIU.

At 230, an access operation (e.g., an RPMB access operation, the write operation 233) may be initiated. For example, the memory system 210 may initiate the write operation 233 on at least a portion of an RPMB of the memory system 210. In some cases, the controller (e.g., the memory system controller 115) or the RPMB access component 140 of the memory system 210 may initiate (e.g., and perform) the write operation 233. In some cases, the memory system 210 may initiate the write operation 233 at a first time in response to (e.g., based on, after, according to) the first SPO command and the data transfer portion 217, and the write operation 233 may be associated with accessing (e.g., writing) the data at the memory array (e.g., a portion of the RPMB) of the memory system 210. For example, the first SPO command and the packets exchanged via the data transfer portion 217 may indicate data to be written to the memory system 210.

At 235, a response to the first SPO command (e.g., a first response UPIU) may be transmitted. For example, the memory system 210 may transmit a first response UPIU to the host system 205. In some cases, the controller (e.g., the memory system controller 115) or the RPMB access component 140 of the memory system 210 may transmit the first response UPIU. In some cases, the memory system 210 may transmit the first response UPIU prior to the first time (e.g., prior to initiation of the write operation 233) or concurrent with performing the write operation 233 (e.g., at the same time as or after initiation of the write operation 233).

The memory system may verify the first SPO command prior to transmitting the first response UPIU at 235. Verifying the first SPO command may include determining that the first SPO command is from the host system 205 according to a signature or other identifier associated with the first SPO command. In some cases, the memory system 210 may transmit the first response UPIU in response to (e.g., based on, after) verifying the first SPO command. The first response UPIU may indicate a status of the memory system 210 in response to receiving, processing, and verifying the first SPO command. For example, the first response UPIU may be a “GOOD” response, as described herein, in response to successfully receiving and verifying the first SPO command. Otherwise, the first response UPIU may indicate an error state of the memory system 210 or an error associated with receiving and verifying the first SPO command, in which case the process may return to 215.

At 240, another security protocol command (e.g., a third security protocol command, a second SPO command) may be received concurrently with performing the write operation 233. For example, the memory system 210 may receive the second SPO command from the host system 205 while writing the data indicated by the data out command of 225. In some cases, the controller (e.g., the memory system controller 115) or the RPMB access component 140 of the memory system 210 may receive the second SPO command. In some cases, the memory system 210 may receive the second SPO command in response to transmitting the first response UPIU at 235. For example, if the first response UPIU is a “GOOD” response, the host system 205 may transmit the second SPO to the memory system 210 to request a read (e.g., an RPMB read operation) of data indicated by the second SPO command. In some cases, the second SPO command may indicate data that is the same as the data indicated by the first SPO command. In some cases, the memory system 210 may wait until completion of the write operation 233 to read the data indicated by the second SPO command to the host system 205.

At 245, a second ready to transfer UPIU may be transmitted. For example, the memory system 210 may transmit the second ready to transfer UPIU to the host system 205 in response to receiving the second SPO command and concurrently with performing the write operation 233. In some cases, the memory system 210 may transmit the second ready to transfer UPIU concurrent with performing the write operation 233. In some cases, the controller (e.g., the memory system controller 115) or the RPMB access component 140 of the memory system 210 may transmit the second ready to transfer UPIU. In some cases, the second ready to transfer UPIU may indicate to the host system 205 that the memory system 210 is ready to receive data associated with the access operation requested by the second SPO (e.g., the read). For example, the data may include addresses or data to be read from the RPMB of the memory system 210 associated with the first SPO.

At 250, a second data out UPIU may be received. For example, the memory system 210 may receive the second data out UPIU from the host system 205 concurrently with performing the write operation 233. In some cases, the controller (e.g., the memory system controller 115) or the RPMB access component 140 of the memory system 210 may receive the second data out UPIU from the host system 205. In some cases, the second data out UPIU may contain the data associated with the read requested by the second SPO.

At 255, a second response UPIU may be transmitted. For example, the memory system 210 may transmit the second response UPIU to the host system 205 concurrently with performing the write operation 233. In some cases, the controller (e.g., the memory system controller 115) or the RPMB access component 140 of the memory system 210 may transmit the second response UPIU. In some cases, the second response UPIU may indicate a status of the memory system 210 associated with the second SPO command. For example, the second response UPIU may indicate a result of verifying the second SPO command, a success or failure associated with receiving or processing the second SPO command, or any combination thereof.

In some cases, the memory system 210 may perform the read operation requested by the second SPO command according to the data indicated by the second data out UPIU. For example, the memory system 210 may perform the read operation before, concurrent with, or after transmitting the second response UPIU to the host system 205. Additionally, or alternatively, the memory system 210 may wait until after a second time at which the write operation 233 is complete to perform or conclude (e.g., terminate) the read operation indicated by the second SPO command. The memory system 210 may refrain from transmitting the results of the read command indicated by the second SPO command to the host system 205 until after completion of the write operation 233.

At 260, another security protocol command (e.g., the second security protocol command, an SPI command) may be received. For example, the memory system 210 may receive an SPI command from the host system 205 concurrently with performing the write operation 233 (e.g., after the first time at which the memory system initiates the write operation 233 and before the second time at which the memory system 210 completes the write operation 233). In some cases, the controller (e.g., the memory system controller 115) or the RPMB access component 140 of the memory system 210 may receive the SPI command. In some cases, the SPI command may request a transmission of the data indicated by the second SPO command to the host system 205. For example, the SPI command may indicate the memory system 210 to transmit the data written during the write operation 233 to the host system 205.

At 263, the write operation 233 may be completed. For example, the memory system 210 may complete the write operation 233 at 263. In some cases, the controller (e.g., the memory system controller 115) or the RPMB access component 140 of the memory system 210 may complete the write operation 233. In some aspects, 263 may be the second time at which the memory system 210 completes the write operation 233. The write operation 233 may be complete if the memory system 210 successfully writes all of the data to the requested memory location.

At 265, second data (e.g., a data in UPIU) may be transmitted. For example, the memory system 210 may transmit a data in UPIU to the host system 205 after the second time at which the memory system 210 completes the write operation 233. In some cases, the controller (e.g., the memory system controller 115) or the RPMB access component 140 of the memory system 210 may transmit the data in UPIU to the host system 205. In some examples, the data in UPIU may indicate a result of the write operation 233 according to the second SPO command requesting the read of the data and the SPI command requesting the transmission of the data to the host system 205.

At 270, a third response UPIU associated with the SPI command may be transmitted. For example, the memory system 210 may transmit the third response UPIU to the host system 205. In some cases, the controller (e.g., the memory system controller 115) or the RPMB access component 140 of the memory system 210 may transmit the third response UPIU. In some examples, the third response UPIU may indicate a status of the memory system 210 associated with the SPI command. For example, the third response UPIU may indicate success or failure in receiving the SPI command, processing the SPI command, or both.

Although a quantity of commands, messages, and data are described as being communicated in the context of process 200, the techniques described herein may apply to any quantity of commands, messages, and data. For example, the process 200 may include more SPO commands, SPI commands, or both with accompanying data in or data out UPIUs and response UPIUs.

In this manner, the host system 205 and the memory system 210 may perform an RPMB access operation (e.g., the write operation 233) with a reduced amount of processing delay (e.g., latency). For example, due to hiding latency associated with various security protocol commands (e.g., the SPI command, the second SPO command) in the latency of the RPMB access operations (e.g., the write operation 233), the memory system may see decreases in latency for RPMB access operations at multiple various queue depths (QDs).

FIG. 3 shows an example of a process 300 that supports adjusted access operations for RPMBs in accordance with examples as disclosed herein. In some cases, aspects of the process 300 may implement or be implemented by aspects of FIGS. 1-3. For example, the process 300 may include a host system 305, which may be an example of the host system 105, the host system 305, or the host system 305 as described herein with respect to FIGS. 1-3. Additionally, the process 300 may include a memory system 310, which may be an example of the memory system 110 and the memory system 210, as described herein with respect to FIGS. 1 and 2. In some aspects, the memory system 310 may communicate one or more security protocol commands associated with accessing memory in an RPMB concurrently with performing an RPMB read operation.

The process 300 may include communication of one or more commands, including security protocol command, for access to RPMB memory. As used herein, SPO commands and SPI commands may be associated with access to a RPMB of the memory system 310. Security protocol commands and RPMB memory may be described in further detail elsewhere herein, including with reference to FIG. 3.

As described herein, in some memory systems, RPMB access operations may be associated with higher relative latency that other access operations (e.g., other access operations for non-protected memory). In some cases, the higher latency may result from the memory system performing the RPMB access operation sequentially with other commands (e.g., including other security protocol commands). That is, the memory system may not communicate other commands concurrent with performing an RPMB access operation. Such a procedure may add latency to receiving commands and performing actions associated with the other commands at the memory system, thus increasing latency associated with RPMB access commands at the memory system. However, by implementing techniques described herein, the memory system 310 may reduce or remove this higher latency.

In the following description of the process 300, the operations may be performed in a different order than the order shown, or other operations may be added or removed from the process 300. For example, some operations may also be left out of process 300, may be performed in different orders or at different times, or other operations may be added to process 300. Although the host system 305 and the memory system 310 are shown performing the operations of process 300, some aspects of some operations may also be performed by one or more other devices of a memory system, the host system 305, or the memory system 310. Additionally, each step that the host system 305 may be responsible for in process 300 may be implemented in instructions or firmware stored in memory of the host system 305 and executed by the host system controller 106. Similarly, each step that memory system 310 may be responsible for in the process 300 may be implemented in instructions or firmware stored in memory of the memory system 310 (e.g., memory device 130) and executed by the memory system controller 115, a local controller 135, or the RPMB access component 140.

At 315, a first security protocol command (e.g., a first SPO command) may be communicated. For example, a memory system (e.g., the memory system 310) may receive the first SPO command from a host system (e.g., the host system 305). In some cases, the first SPO command may be received at a controller (e.g., the memory system controller 115) or an RPMB access component (e.g., the RPMB access component 140) of the memory system. In some cases, the first SPO command may indicate data associated with an access operation for a memory array (e.g., an RPMB) of the memory system 310. For example, the data may include data to be read from the memory array, an address associated with the memory array, or both. Additionally, the first SPO command may indicate that the access operation is a read operation 333.

At 320, at least one first information unit (e.g., a first ready to transfer UPIU) may be transmitted. For example, the memory system 310 may transmit a first ready to transfer UPIU to the host system 305. In some cases, the controller (e.g., the memory system controller 115) or the RPMB access component 140 of the memory system 310 may transmit the first ready to transfer UPIU. In some cases, the first ready to transfer UPIU may indicate that the memory system is ready to receive the data (e.g., memory addresses to be read) indicated by the first SPO command.

At 325, at least one second information unit (e.g., a first data out UPIU) may be received. For example, the memory system 310 may receive a first data out UPIU from the host system 305 in response to transmitting the ready to transfer UPIU of 320. In some cases, the controller (e.g., the memory system controller 115) or the RPMB access component 140 of the memory system 310 may receive the first data out UPIU. The first data out UPIU may contain at least a portion of the data indicated by the first SPO command. For example, the access operation indicated by the first SPO command may be the read operation 333, and may be to read the indicated data in response to receiving the first data out UPIU.

At 330, an access operation (e.g., an RPMB access operation, the read operation 333) may be initiated. For example, the memory system 310 may initiate the read operation 333 on at least a portion of an RPMB of the memory system 310. In some cases, the controller (e.g., the memory system controller 115) or the RPMB access component 140 of the memory system 310 may initiate (e.g., and perform) the read operation 333. In some cases, the memory system 310 may initiate the read operation 333 at a first time in response to the first SPO command, and the read operation 333 may be associated with accessing (e.g., reading) the data at the memory array (e.g., a portion of the RPMB) of the memory system 310. For example, the first SPO command may indicate data to be read from the memory system 310.

At 335, a response to the first SPO command (e.g., a first response UPIU) may be transmitted. For example, the memory system 310 may transmit a first response UPIU to the host system 305. In some cases, the controller (e.g., the memory system controller 115) or the RPMB access component 140 of the memory system 310 may transmit the first response UPIU. In some cases, the memory system 310 may transmit the first response UPIU prior to the first time (e.g., prior to initiation of the read operation 333) or concurrent with performing the read operation 333.

The memory system 310 may verify the first SPO command prior to 335. Verifying the first SPO command may include determining that the first SPO command is from the host system 305 according to a signature or other identifier associated with the first SPO command. In some cases, the memory system 310 may transmit the first response UPIU in response to verifying the first SPO command. For example, the first response UPIU may indicate a status of the memory system 310 in response to receiving, processing, and verifying the first SPO command. For example, the first response UPIU may be a “GOOD” response, as described herein, in response to successfully receiving and verifying the first SPO command. Otherwise, the first response UPIU may indicate an error state of the memory system 310 or an error associated with receiving and verifying the first SPO command, in which case the process may return to 315.

At 340, another security protocol command (e.g., the second security protocol command, an SPI command) may be received. For example, the memory system 310 may receive an SPI command from the host system 305 concurrently with performing the read operation 333 (e.g., after the first time at which the memory system initiates the read operation 333 and before the second time at which the memory system 310 completes the read operation 333). In some cases, the controller (e.g., the memory system controller 115) or the RPMB access component 140 of the memory system 310 may receive the SPI command. In some cases, the SPI command may request a transmission of the data indicated by the first SPO command to the host system 305. For example, the SPI command may indicate the memory system 310 to transmit the data read in the read operation 333 to the host system 305.

At 345, the read operation 333 may be completed. For example, the memory system 310 may complete the read operation 333 at 345. In some cases, the controller (e.g., the memory system controller 115) or the RPMB access component 140 of the memory system 310 may complete the read operation 333. In some aspects, 345 may be the second time at which the memory system 310 completes the read operation 333.

At 350, another UPIU (e.g., a data in UPIU) may be transmitted. For example, the memory system 310 may transmit a data in UPIU to the host system 305 after the second time at which the memory system 310 completes the read operation 333. In some cases, the controller (e.g., the memory system controller 115) or the RPMB access component 140 of the memory system 310 may transmit the data in UPIU to the host system 305. In some examples, the data in UPIU may indicate a result of the read operation 333 according to the SPI command requesting the transmission of the data to the host system 305. For example, the data in UPIU may indicate a success or failure status of the read operation 333, the data read from the RPMB of the memory system 310, or both.

At 355, a second response UPIU associated with the SPI command may be transmitted. For example, the memory system 310 may transmit the second response UPIU to the host system 305. In some cases, the controller (e.g., the memory system controller 115) or the RPMB access component 140 of the memory system 310 may transmit the second response UPIU. In some examples, the second response UPIU may indicate a status of the memory system 310 associated with the SPI command. For example, the second response UPIU may indicate success or failure in receiving the SPI command, processing the SPI command, or both.

In this manner, the host system 305 and the memory system 310 may perform an RPMB access operation (e.g., the read operation 333) with a reduced amount of processing delay (e.g., latency). Although a quantity of commands, messages, and data are described as being communicated in the context of process 300, the techniques described herein may apply to any quantity of commands, messages, and data. For example, the process 300 may include more SPO commands, SPI commands, or both with accompanying data in or data out UPIUs and response UPIUs.

FIG. 4 shows a block diagram 400 of a memory system 420 that supports adjusted access operations for RPMBs in accordance with examples as disclosed herein. The memory system 420 may be an example of aspects of a memory system as described with reference to FIGS. 1 through 3. The memory system 420, or various components thereof, may be an example of means for performing various aspects of adjusted access operations for RPMBs as described herein. For example, the memory system 420 may include a security protocol command component 425, an access operation component 430, a command verification component 435, a response transmission component 440, an information unit transmission component 445, an information unit reception component 450, a data transmission component 455, or any combination thereof. Each of these components, or components of subcomponents thereof (e.g., one or more processors, one or more memories), may communicate, directly or indirectly, with one another (e.g., via one or more buses).

The memory system 420 may support operating a memory system in accordance with examples as disclosed herein. The security protocol command component 425 may be configured as or otherwise support a means for receiving a first security protocol command that indicates data associated with an access operation for a memory array of the memory system. The access operation component 430 may be configured as or otherwise support a means for initiating, at a first time based at least in part on the first security protocol command, the access operation associated with accessing the data at the memory array of the memory system. In some examples, the security protocol command component 425 may be configured as or otherwise support a means for receiving, after the first time, concurrent with performing the access operation, and before a second time at which the access operation is complete, a second security protocol command that requests transmission of the data to a host device.

In some examples, the command verification component 435 may be configured as or otherwise support a means for verifying the first security protocol command. In some examples, the response transmission component 440 may be configured as or otherwise support a means for transmitting, before the first time or concurrent with performing the access operation, a response to the first security protocol command based at least in part on verifying the first security protocol command, the response indicating a status of the memory system based at least in part on the first security protocol command, where the second security protocol command is received based at least in part on the response.

In some examples, to support initiating the access operation, the access operation component 430 may be configured as or otherwise support a means for initiating a read operation based at least in part on the first security protocol command indicating the data to be read from the memory system.

In some examples, the data transmission component 455 may be configured as or otherwise support a means for transmitting, to the host device after the second time at which the read operation is complete, the data based at least in part on the second security protocol command.

In some examples, to support initiating the access operation, the access operation component 430 may be configured as or otherwise support a means for initiating a write operation based at least in part on the first security protocol command indicating the data to be written to the memory system.

In some examples, the security protocol command component 425 may be configured as or otherwise support a means for receiving, concurrent with performing the write operation, a third security protocol command that requests a read of the data indicated via the first security protocol command. In some examples, the data transmission component 455 may be configured as or otherwise support a means for transmitting, to the host device after the second time at which the write operation is complete, second data that indicates a result of the write operation based at least in part on the read of the data and the second security protocol command that requests the transmission of the data to the host device.

In some examples, the information unit transmission component 445 may be configured as or otherwise support a means for transmitting, to the host device based at least in part on the first security protocol command, at least one first information unit that indicates that the memory system is ready to receive the data. In some examples, the information unit reception component 450 may be configured as or otherwise support a means for receiving, based at least in part on the transmission of the at least one first information unit, at least one second information unit including at least a portion of the data, where the access operation includes a write operation to write the data based at least in part on the at least one second information unit.

In some examples, the information unit transmission component 445 may be configured as or otherwise support a means for transmitting, to the host device based at least in part on the first security protocol command, at least one first information unit that indicates that the memory system is ready to receive an indication of the data. In some examples, the information unit reception component 450 may be configured as or otherwise support a means for receiving, based at least in part on the transmission of the at least one first information unit, at least one second information unit including the indication of the data, where the access operation includes a read operation to read the indicated data based at least in part on the at least one second information unit.

In some examples, the first security protocol command and the second security protocol command are associated with access to an RPMB.

In some examples, the described functionality of the memory system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 420, or various components thereof, may be implemented at least in part by instructions (e.g., stored in memory, non-transitory computer-readable medium) executable by such at least one processor.

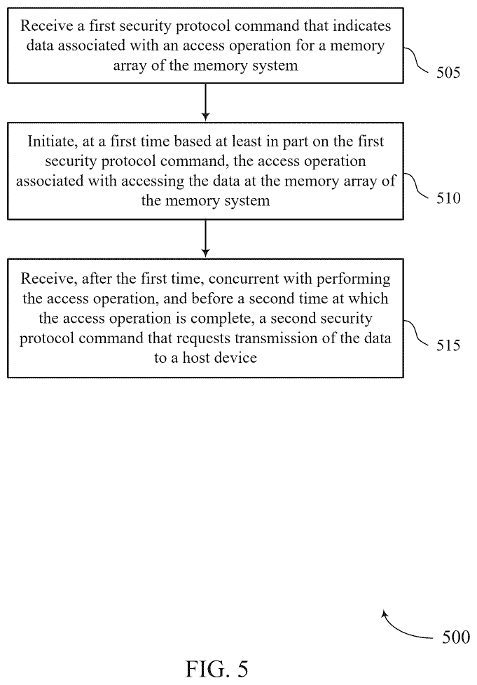

FIG. 5 shows a flowchart illustrating a method 500 that supports adjusted access operations for RPMBs in accordance with examples as disclosed herein. The operations of method 500 may be implemented by a memory system or its components as described herein. For example, the operations of method 500 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 505, the method may include receiving a first security protocol command that indicates data associated with an access operation for a memory array of the memory system. In some examples, aspects of the operations of 505 may be performed by a security protocol command component 425 as described with reference to FIG. 4.

At 510, the method may include initiating, at a first time based at least in part on the first security protocol command, the access operation associated with accessing the data at the memory array of the memory system. In some examples, aspects of the operations of 510 may be performed by an access operation component 430 as described with reference to FIG. 4.

At 515, the method may include receiving, after the first time, concurrent with performing the access operation, and before a second time at which the access operation is complete, a second security protocol command that requests transmission of the data to a host device. In some examples, aspects of the operations of 515 may be performed by a security protocol command component 425 as described with reference to FIG. 4.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for receiving a first security protocol command that indicates data associated with an access operation for a memory array of the memory system; initiating, at a first time based at least in part on the first security protocol command, the access operation associated with accessing the data at the memory array of the memory system; and receiving, after the first time, concurrent with performing the access operation, and before a second time at which the access operation is complete, a second security protocol command that requests transmission of the data to a host device.

Aspect 2: The method, apparatus, or non-transitory computer-readable medium of aspect 1, further including operations, features, circuitry, logic, means, or instructions, or any combination thereof for verifying the first security protocol command and transmitting, before the first time or concurrent with performing the access operation, a response to the first security protocol command based at least in part on verifying the first security protocol command, the response indicating a status of the memory system based at least in part on the first security protocol command, where the second security protocol command is received based at least in part on the response.

Aspect 3: The method, apparatus, or non-transitory computer-readable medium of any of aspects 1 through 2, where initiating the access operation includes operations, features, circuitry, logic, means, or instructions, or any combination thereof for initiating a read operation based at least in part on the first security protocol command indicating the data to be read from the memory system.

Aspect 4: The method, apparatus, or non-transitory computer-readable medium of aspect 3, further including operations, features, circuitry, logic, means, or instructions, or any combination thereof for transmitting, to the host device after the second time at which the read operation is complete, the data based at least in part on the second security protocol command.

Aspect 5: The method, apparatus, or non-transitory computer-readable medium of any of aspects 1 through 3, where initiating the access operation includes operations, features, circuitry, logic, means, or instructions, or any combination thereof for initiating a write operation based at least in part on the first security protocol command indicating the data to be written to the memory system.

Aspect 6: The method, apparatus, or non-transitory computer-readable medium of aspect 5, further including operations, features, circuitry, logic, means, or instructions, or any combination thereof for receiving, concurrent with performing the write operation, a third security protocol command that requests a read of the data indicated via the first security protocol command and transmitting, to the host device after the second time at which the write operation is complete, second data that indicates a result of the write operation based at least in part on the read of the data and the second security protocol command that requests the transmission of the data to the host device.

Aspect 7: The method, apparatus, or non-transitory computer-readable medium of any of aspects 1 through 6, further including operations, features, circuitry, logic, means, or instructions, or any combination thereof for transmitting, to the host device based at least in part on the first security protocol command, at least one first information unit that indicates that the memory system is ready to receive the data and receiving, based at least in part on the transmission of the at least one first information unit, at least one second information unit including at least a portion of the data, where the access operation includes a write operation to write the data based at least in part on the at least one second information unit.

Aspect 8: The method, apparatus, or non-transitory computer-readable medium of any of aspects 1 through 7, further including operations, features, circuitry, logic, means, or instructions, or any combination thereof for transmitting, to the host device based at least in part on the first security protocol command, at least one first information unit that indicates that the memory system is ready to receive an indication of the data and receiving, based at least in part on the transmission of the at least one first information unit, at least one second information unit including the indication of the data, where the access operation includes a read operation to read the indicated data based at least in part on the at least one second information unit.

Aspect 9: The method, apparatus, or non-transitory computer-readable medium of any of aspects 1 through 8, where the first security protocol command and the second security protocol command are associated with access to a RPMB.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

As used herein, the term “substantially” means that the modified characteristic (e.g., a verb or adjective modified by the term substantially) need not be absolute but is close enough to achieve the advantages of the characteristic.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed and second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed and second condition or action may occur directly as a result of the previous condition or action occurring independent of whether other conditions or actions occur. In some examples, a first condition or action may be performed and second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk, and Blu-ray disc, where disks usually reproduce data magnetically, while discs reproduce data optically with lasers. Combinations of these are also included within the scope of computer-readable media.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
receive a first security protocol command that indicates data associated with an access operation for a memory array of the memory system;
initiate, at a first time based at least in part on the first security protocol command, the access operation associated with accessing the data at the memory array of the memory system; and
receive, after the first time, concurrent with performing the access operation, and before a second time at which the access operation is complete, a second security protocol command that requests transmission of the data to a host device.

2. The memory system of claim 1, wherein the processing circuitry is further configured to cause the memory system to:
verify the first security protocol command; and
transmit, before the first time or concurrent with performing the access operation, a response to the first security protocol command based at least in part on verifying the first security protocol command, the response indicating a status of the memory system based at least in part on the first security protocol command, wherein the second security protocol command is received based at least in part on the response.

3. The memory system of claim 1, wherein, to initiate the access operation, the processing circuitry is configured to cause the memory system to:
initiate a read operation based at least in part on the first security protocol command indicating the data to be read from the memory system.

4. The memory system of claim 3, wherein the processing circuitry is further configured to cause the memory system to:
transmit, to the host device after the second time at which the read operation is complete, the data based at least in part on the second security protocol command.

5. The memory system of claim 1, wherein, to initiate the access operation, the processing circuitry is configured to cause the memory system to:
initiate a write operation based at least in part on the first security protocol command indicating the data to be written to the memory system.

6. The memory system of claim 5, wherein the processing circuitry is further configured to cause the memory system to:
receive, concurrent with performing the write operation, a third security protocol command that requests a read of the data indicated via the first security protocol command; and
transmit, to the host device after the second time at which the write operation is complete, second data that indicates a result of the write operation based at least in part on the read of the data and the second security protocol command that requests the transmission of the data to the host device.

7. The memory system of claim 1, wherein the processing circuitry is further configured to cause the memory system to:
transmit, to the host device based at least in part on the first security protocol command, at least one first information unit that indicates that the memory system is ready to receive the data; and
receive, based at least in part on the transmission of the at least one first information unit, at least one second information unit comprising at least a portion of the data, wherein the access operation comprises a write operation to write the data based at least in part on the at least one second information unit.

8. The memory system of claim 1, wherein the processing circuitry is further configured to cause the memory system to:
transmit, to the host device based at least in part on the first security protocol command, at least one first information unit that indicates that the memory system is ready to receive an indication of the data; and
receive, based at least in part on the transmission of the at least one first information unit, at least one second information unit comprising the indication of the data, wherein the access operation comprises a read operation to read the indicated data based at least in part on the at least one second information unit.

9. The memory system of claim 1, wherein the first security protocol command and the second security protocol command are associated with access to a replay protected memory block.

10. A non-transitory computer-readable medium storing code comprising instructions which, when executed by one or more processors of a memory system, cause the memory system to:
receive a first security protocol command that indicates data associated with an access operation for a memory array of the memory system;
initiate, at a first time based at least in part on the first security protocol command, the access operation associated with accessing the data at the memory array of the memory system; and
receive, after the first time, concurrent with performing the access operation, and before a second time at which the access operation is complete, a second security protocol command that requests transmission of the data to a host device.

11. The non-transitory computer-readable medium of claim 10, wherein the instructions, when executed by the one or more processors of the memory system, further cause the memory system to:
verify the first security protocol command; and
transmit, before the first time or concurrent with performing the access operation, a response to the first security protocol command based at least in part on verifying the first security protocol command, the response indicating a status of the memory system based at least in part on the first security protocol command, wherein the second security protocol command is received based at least in part on the response.

12. The non-transitory computer-readable medium of claim 10, wherein the instructions to initiate the access operation, when executed by the one or more processors of the memory system, cause the memory system to:
initiate a read operation based at least in part on the first security protocol command indicating the data to be read from the memory system.

13. The non-transitory computer-readable medium of claim 12, wherein the instructions, when executed by the one or more processors of the memory system, further cause the memory system to:
transmit, to the host device after the second time at which the read operation is complete, the data based at least in part on the second security protocol command.

14. The non-transitory computer-readable medium of claim 10, wherein the instructions to initiate the access operation, when executed by the one or more processors of the memory system, cause the memory system to:
initiate a write operation based at least in part on the first security protocol command indicating the data to be written to the memory system.

15. The non-transitory computer-readable medium of claim 14, wherein the instructions, when executed by the one or more processors of the memory system, further cause the memory system to:
receive, concurrent with performing the write operation, a third security protocol command that requests a read of the data indicated via the first security protocol command; and
transmit, to the host device after the second time at which the write operation is complete, second data that indicates a result of the write operation based at least in part on the read of the data and the second security protocol command that requests the transmission of the data to the host device.

16. The non-transitory computer-readable medium of claim 10, wherein the instructions, when executed by the one or more processors of the memory system, further cause the memory system to:
transmit, to the host device based at least in part on the first security protocol command, at least one first information unit that indicates that the memory system is ready to receive the data; and
receive, based at least in part on the transmission of the at least one first information unit, at least one second information unit comprising at least a portion of the data, wherein the access operation comprises a write operation to write the data based at least in part on the at least one second information unit.

17. The non-transitory computer-readable medium of claim 10, wherein the instructions, when executed by the one or more processors of the memory system, further cause the memory system to:
transmit, to the host device based at least in part on the first security protocol command, at least one first information unit that indicates that the memory system is ready to receive an indication of the data; and
receive, based at least in part on the transmission of the at least one first information unit, at least one second information unit comprising the indication of the data, wherein the access operation comprises a read operation to read the indicated data based at least in part on the at least one second information unit.

18. The non-transitory computer-readable medium of claim 10, wherein the first security protocol command and the second security protocol command are associated with access to a replay protected memory block.

19. A method for operating a memory system, comprising:
receiving a first security protocol command that indicates data associated with an access operation for a memory array of the memory system;
initiating, at a first time based at least in part on the first security protocol command, the access operation associated with accessing the data at the memory array of the memory system; and
receiving, after the first time, concurrent with performing the access operation, and before a second time at which the access operation is complete, a second security protocol command that requests transmission of the data to a host device.

20. The method of claim 19, further comprising:
verifying the first security protocol command; and
transmitting, before the first time or concurrent with performing the access operation, a response to the first security protocol command based at least in part on verifying the first security protocol command, the response indicating a status of the memory system based at least in part on the first security protocol command, wherein the second security protocol command is received based at least in part on the response.
